(19) United States
(12) Patent Application Publication
(10) Pub. No.: US 2015/0356714 A1
(43) Pub. Date: Dec. 10, 2015

(54) SYSTEM AND METHOD FOR USING DIGITAL DISPLAYS WITHOUT OPTICAL CORRECTION DEVICES

(71) Applicant: Mehran Moalem, Cupertino, CA (US)

(72) Inventor: Mehran Moalem, Cupertino, CA (US)

(21) Appl. No.: 14/663,284

(22) Filed: Mar. 19, 2015

Related U.S. Application Data
(60) Provisional application No. 62/009,289, filed on Jun. 8, 2014.

(51) Int. Cl. G06T 5/00; H04N 9/31; G09G 3/00; H04N 5/66

(52) U.S. Cl. CPC G06T 5/003; H04N 5/66; H04N 9/31; G09G 3/006; G06T 5/006; G09G 2320/02; G09G 2320/0693; G09G 2320/0233; G09G 2360/147; G06T 2200/28; G06T 2207/10152; G06T 2207/10148; G06T 2207/20204; G06T 2207/20228

(57) ABSTRACT

A computer implemented system and method to produce display screen images intended to be seen clearly by users with various eye problems such as myopia and astigmatism. Here the system receives input regarding the desired optical correction needed to allow the user to see the image clearly, such as by determining the distance to the user and also optionally calibrating the system according to the degree of optical correction needed by the user. In some embodiments, the display screen may have a plurality of pixel addressed light deflectors configured to change the angle of light emitted by the display screen at various locations in order to bring the computer generated image in better focus. In other embodiments, the system may convolute the display images in order to compensate for eye abnormalities such as astigmatism. In other embodiments, both light deflectors and image convolution methods may be used.

### CROSS REFERENCE TO RELATED APPLICATIONS

This application claims the priority benefit of U.S. provisional application 62/009,289, “System and method for using digital displays without optical correction devices”, filed Jun. 8, 2014, inventor Mehran Moalem, the entire contents of which are incorporated herein by reference.

### BACKGROUND OF THE INVENTION

Digital displays such as computer monitors, mobile phone displays, and digital TV displays are the means by which information is displayed visually for most information technology and entertainment devices. Such displays represent a key interface with the user, and are used to transmit both text and images (e.g. still images, and video) to the user's eyes.

Historically, however, there is little prior art, outside of head mounted displays, that attempt to tune or adjust such computer driven display interfaces to a specific user's visual requirements. This is unfortunate, because over 60% of the human population is affected by common visual impairments such myopia, hyperopia, presbyopia, astigmatism and the like. Currently such users may have to wear special corrective devices such as eye glasses or contact lenses before using digital devices and monitors.

Thus improved systems and methods that would allow such users to use standard (non-head mounted) computer display devices would be highly useful.

### BRIEF DESCRIPTION OF THE INVENTION

In this disclosure, improved digital display screen devices to correct for user's visual impairments, thus reducing or eliminating the need for user to wear corrective lenses while using or operating such display screens, are disclosed.

In some embodiments, the invention may be a computer implemented system and method to produce display screen images intended to be seen clearly by users with various eye problems such as myopia and astigmatism. Here the system receives input regarding the desired optical correction needed to allow the user to see the image clearly. This input can include the distance between the display screen and the user (user's eyes). The input can also include information pertaining to the amount of optical correction needed by the user in order to see the display screen clearly.

To apply appropriate display screen corrections in order to allow the user to see the screen clearly, in some embodiments, the display screen may employ a plurality of pixel addressed light deflectors. These deflectors can be configured to change the angle of light emitted by the display screen at various locations, thus bringing the computer generated image in better focus. In other embodiments, the system may convolute or pre-distort the display images in order to compensate for eye abnormalities such as astigmatism. In other embodiments, both light deflectors and image convolution methods may be used.

As will be discussed, the methods and devices disclosed herein can have benefits for users having normal vision as well. An example of such other benefits include higher security, which can be obtained when the device is adjusted or “tuned” to still provide clear images to the intended user positioned at the user's location, but provide degraded clarity to other viewers. The net result would then be to afford better privacy to the intended user. Indeed in some embodiments, the devices and methods disclosed herein can be used to tune or adjust the display monitor so that it only provides clear images to eyes situated at a designated distance from the screen. This makes it much more difficult for unauthorized users to view information presented on the display screen.

### BRIEF DESCRIPTION OF THE DRAWINGS

FIG. 1A shows a schematic of a methodology or algorithm for calculating how light rays from various pixels on display screen emerge to form a unique projection on retina of user's eye.

FIG. 1B shows a schematic of an alternative methodology or algorithm for calculating how light rays from various pixels on display screen emerge to form a unique projection on retina of user's eye.

FIG. 1C shows an example of how pixels display screen (in this example, a 96 dpi display screen) are distributed, according to the optical examples from FIGS. 1A and 1B, into a circle of radius “r” that covers about 49 pixels.

FIG. 2 shows how a layer of optical material with variable optical properties, provided by a plurality of deflector pixel-addressed light deflection devices, can be used to correct user eye impairments, assuming that the eye is located at a particular distance from display screen.

### DETAILED DESCRIPTION OF THE INVENTION

Digital devices have screen cells referred to as pixels that are turned on and off in combination to project an image or text on the screen. The higher the number of pixels the higher the digital resolution of the screen and the higher number of colors in each pixel the higher the color resolution of the screen will be. The state of each pixel is determined by processing chips used in the digital device. Examples of such processors are the special chips in the graphics board of a personal computer or display chips in its motherboard. The objective without the benefit of current invention is for the combined output of the screen pixels appearing as a sharp image viewable without eye strain to the user at a certain distance (typically 30 cm) from the front of the screen.

We use the same or similar hardware but enhance the capability by adding a software solution to defocus the image just enough that it becomes sharp and crisp for an eye which is impaired. For example eyes with myopia are afflicted with a condition that results in the image from an object not forming perfectly on the retina of the eye and instead forming the image some distance in front of the retina. Without corrective lenses the user will see the world including the digital screen out of focus, blurry or fuzzy. In some cases the user can move the eyes very close to or very far from the display device to see a clear image. The corrective lenses prescribed for users operate by optically correcting for the impairment so as to move the position of the image formed inside the eyes back to the eye's retina.

The same effects can be achieved by modifying the original image by software manipulation so the original image is fuzzy and out of focus just enough that when sighted with an impaired eye, a well-resolved image forms on the retina of the eyes of the user, thus eliminating the need to wear glasses, contact lenses, or other optical corrective devices.

In some embodiments, the software applies parameters based on the specific requirements of the user as prescribed by optometrist or ophthalmologist to achieve digitally the same effect that an optical corrective wear would achieve. An alternate technology envisioned here achieves the same correction through a hardware implementation. In that implementation, a layer of material, typically containing plurality of deflector pixel-addressed light deflection devices for which the optical properties can be changed, can be placed on top of screen. This layer can then refract the light emitting from the display screen sufficiently so the total effect will result in the formation of the image at the right place (retina of the eye) without a need for further correction (i.e. wearing eye glasses or contact lenses).

Here we present an example of one method to achieve such correction for user eyes suffering from some refractive error. Refractive error refers to the condition where the eyes of the patient have too much or too little refractive power to properly focus the image onto the retina. The optical power for a lens or mirror, D, is the degree that the device converges or diverges light and is equal to the inverse of the focal length of the device (1/f). For two devices in series the net optical power is additive:

Dₜₒₜₐₗ=D₁+D₂.

The human eye contains various active optical components such as the lens and cornea and is characterized similarly. The net refractive power is referred to as eye diopter (D) and typically determined by the physician during an eye exam. A prescription details this key piece of information and normally used for prescribing corrective eye wear for the patient. The lens of the eye is flexible and changes the net focal length of the eye but the prescription identifies the limits of this focusing effect. When the eye does not have sufficient power to focus the image of an object at infinite distance correctly onto the retina the image actually forms some distance in front or behind the retina. The physician prescribes a corrective lens so that the net optical power will form the image exactly at the location of the retina. Converging lenses have positive and diverging lenses have negative optical power.

For lenses the distance from the object to the lens p, the distance from the lens to the image q and focal length obey the formula

1/p+1/q=1/f

Using this formula, the prescribed impairment of the eye (D), and the distance of the display screen to the eyes (p), one can back calculate what the original image should be in order to result in focused image on the retina without strain to the eye. In this way, the rays of light emerging from multiple pixels of the display screen and travelling in different angles arrive at the same point on the retina after the action of the eye's lens system. For this reason each pixel on the screen should ideally be a composite or convoluted sum of the data from many points in the original image projected on the display screen, so the image deconvoluted by the action of lens system actually reconstructs the origin image intended. Such composite image on the display screen would of course look blurry and out of focus to the eye which does not have the same impairment, or is located a different distance from the screen. However the invention is more generally directed to methods that adapt the display screen to the eyes of a particular user located at a known distance from the screen.

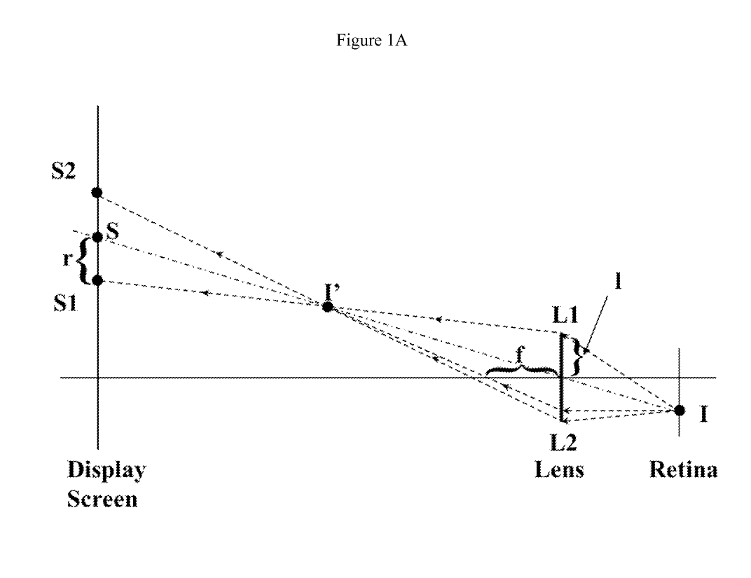

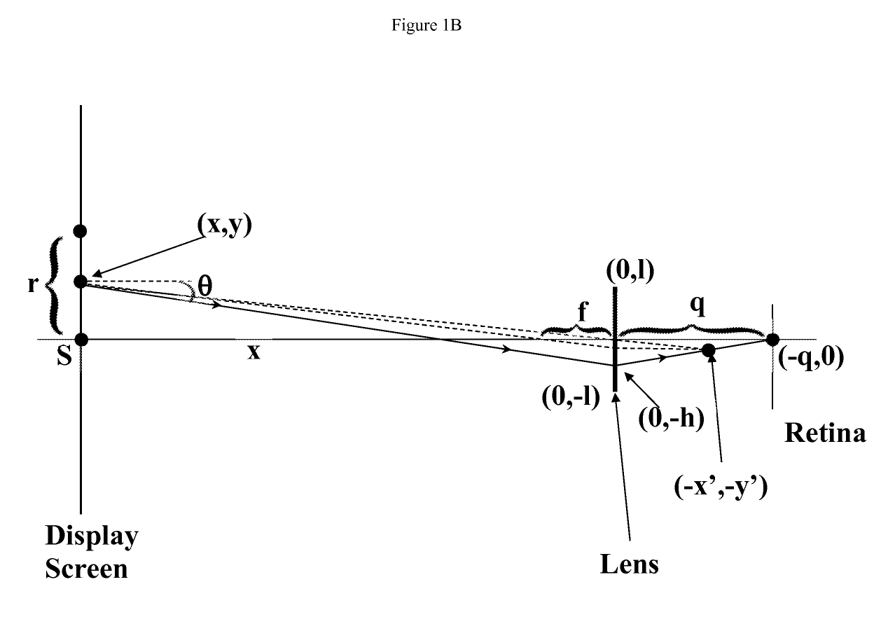

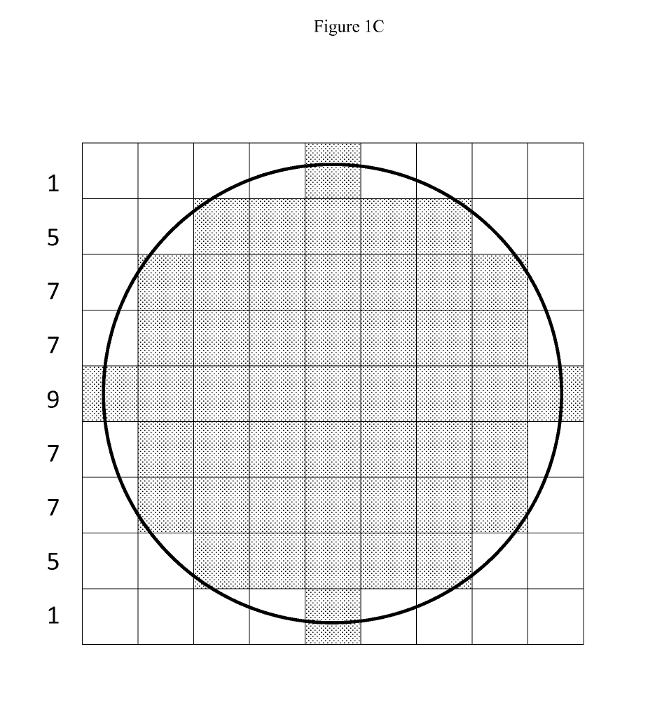

FIGS. 1A and 1B demonstrate various examples for the implementation of this methodology. Generally the ray trace calculations described in FIGS. 1A and 1B can be implemented in software, and run by the digital display device's at least one processor.

Here the actions of the various optically active components of the eye are combined into an effective lens of radius 1 and focal length f. Here assume that the display screen is located a distance X in front of the lens, and retina of the eye where the final image is formed is located at a distance q behind the lens. The original data to be displayed on the screen is a set of values, such as one value for each pixel of the display screen. The highest and lowest points of the lens are designated as L1 and L2, and the corresponding limits on the display screen are S1 and S2. For a point I on the retina located off-axis to be a sharp image of the original pixel, one can calculate where the display screen should have been located in order for this to happen, and that would be distance X′ given by:

1/X′+1/q=1/f

Point I′ would be formed by the virtual object that would have generated a properly-focused image at point I. By extrapolating the rays of the light going from point I to L1 and L2 and crossing at point I′ to the screen positions S1 and S2, the limits of the pixel positions that contribute to the image at retina can be seen. There is also an effect associated with Lambert's law which results in a cosine distribution of light flux. At large distances X, the angular variation is small or negligible. A further simplification can be used at small angles of incidence. Here, since angles are small and distance X significantly exceeds q, an approximation can be made that all pixels contained between S1 and S2 form a circle of radius r, and all points within this circle contribute equally to the final image, independent of the angle of incidence. Using geometry and above approximation r can be calculated:

r/1=X(1/f−1/q)−1

For a numerical example, the active diameter of the eye is 6 mm, the distance of retina to lens, q, is 22 mm, focal distance is 20 mm, and the distance X from eye to display screen is 300 mm. That will result in an r value of 1.09 mm.

For a display screen of resolution 96 dpi, there will be 2.8 pixels per millimeter. As can be seen in FIG. 1C, a circle of radius r will contain 49 pixels, and in effect the value of the pixel on the original screen is now distributed to the adjacent 49 pixels. In other words, the value at each pixel is the sum of contributions from each of the 49 adjacent pixels on the original screen.

The computer program (e.g. the software used by the system's at least one processor) can automatically calculate the composite value for each pixel, and this is the value that is projected on the screen. For black and white screens, the values will be 1 and 0. For a gray scale the values may be many fractional values depending on the gray scale resolution. For a color screen each pixel has multiple colors, and for each color this composite value is independently calculated.

For a moving image (e.g. video) the screen can be refreshed at a designated rate per unit time (e.g. 30 or 60 frames per second). The program (or graphics chip) will recalculate a new set of pixel values each time the values are refreshed, and so long as this recalculation is done faster than the frame rate, a sharp video should also be projected onto the user's eye as well, without a need for optical correction eye wear.

As a general rule the higher the resolution of the display screen, the better this transformation will work. With higher resolution screens, such as a 200 dpi, 300 dpi, or higher resolutions, better customization of the image to the user's eye, and thus sharper images, can be obtained.

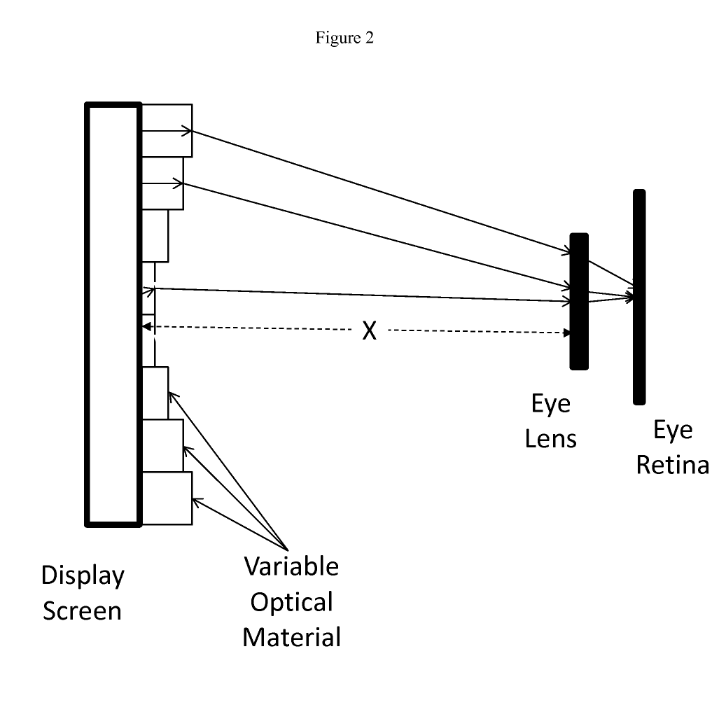

FIG. 2 depicts the methodology where the corrective effect can be achieved purely by physical means (hardware).

Here a layer of optically active material, containing the various deflector pixel-addressed light deflection devices, is placed on top of the display screen. These light deflection devices can locally change shape, and thus optical paths, under the effect of applied electric or magnetic field.

In some embodiments, these various deflector pixel-addressed light deflection devices can be formed from pixels of transparent piezoelectric material, configured to change thickness under the effect of applied electric fields. The various parts of the layers can be manipulated differently so the net effect simulates the action of a lens of power D equal to the correction required to makeup at the distance X for the impairment of the target eye.

Using this method no manipulation (e.g. convolution) of the original display data may be required and the original image on the screen (prior to the action of the deflectors on the optical material on top of the screen) need not be corrected for any user visual defects. Instead, the entire corrective function can be performed by device's processor sending correction commands to the plurality of deflector pixel-addressed light deflection devices.

Depending on the image being presented and the amount of optical correction required, often it may not be necessary to activate every pixel-addressed deflector in the top layer of material. For example, sometimes the various deflector pixels may only need to be manipulated over various zones, thus approximating a larger lens by an arrangement of the deflector pixels to form series of concentric light bending rings, for example.

Thus in some embodiments, the invention may be a device or a method of modifying an image on a display screen of a digital display device (e.g. a display device typically having at least one computer processor such as a microprocessor) so as to make one or more computer generated images (or video) properly focus on at least one retina of at least one eye of a user viewing that display screen. This method or device will often operate by first receiving input regarding a desired optical correction needed to make the images properly focus on the user's retina.

Often the users will have less than perfect vision. As previously discussed, the device can be configured to work with various types of imperfect vision, such as natural impairments including sub-optimal focus (e.g. myopia, hyperopia, presbyopia, astigmatism, anisometropia) or limited visual field angles. In some embodiments, the system can even be configured to operate with various impairments of the user's retinal cone cells, such as color blindness.

In some embodiments, particularly for myopia, hyperopia, and presbyopia, the optical correction input needed to make image properly focus on the user's retina will comprise at least the distance (distance value) between the user's eye and the display screen. This distance value could of course, be a default value either loaded onto the system initially, or entered in by the user (e.g. using a keyboard, mouse, touch screen etc.).

However in other embodiments, it will be useful to use at least one user observation sensor, preferably mounted or incorporated into the digital display device. This user observation sensor can be a camera, or an ultrasonic sensor, or other type optical scanner. This user observation sensor can be configured to measure or otherwise determine the distance between the digital display device's display screen and the user's eyes and head.

Here, as an example, we will assume that the user observation sensor is a camera mounted on the digital display device, and positioned to view the user. The device processor, for example, can be configured (e.g. programmed with software) to examine certain user features, such as the distance between the user's eyes, and using assumptions or preloaded coefficients regarding the true distance between the user's eyes, determine the distance between the user's eyes and the display screen. Here for example, the software can determine the apparent distance between the user's eyes using the camera input, and compute the distance between these eyes and the display screen using triangulation or other relatively simple mathematical process.

Note that in cases where the user has impaired vision, the input regarding a desired optical correction needed to make the images properly focus on the user's retina will often also incorporate information regarding the user's vision impairment. In some cases, this can be entered directly by the user (e.g. the user can enter that his eyes require −5.0 diopter lenses), and the system can take this as well. Often, however, the system may require an initial calibration step where the user is presented with a series of computer generated images, and with various possible correction factors, and invited to inform the system as to which setting gives the clearest image. Such calibration methods can be particularly useful for astigmatism, because here the computer can generate images with various potential astigmatism amounts and angles, and once calibrated can then retain these settings for as long as desired.

In some embodiments, the system can be further configured so that when the user logs on, or when the camera, processor, and software automatically recognize the user, the system could automatically retrieve information pertaining to that user's visual impairment from system memory, and use it for subsequent display corrections.

Once the input regarding a desired optical correction needed to make the images properly focus on the user's retina has been obtained, the system must then use this input to adjust the computer display image. This adjustment can be done by various ways.

In one embodiment (here called option “a”) the digital display device's display screen can be equipped with a plurality of deflector pixel-addressed light deflection devices. Here each of these light deflection devices will typically be configured to change an angle of light emitted by the digital display device according to commands from the device's at least one computer processor.

In this embodiment, the device can use the desired optical correction input, and the device's at least one computer processor, as well as suitable optical correction hardware (e.g. FPGA, ASICS, or DSP processors) or optical correction software to send angle adjustment commands to at least some of these various deflector pixel-addressed light deflection devices. These commands will configure at least some of these various deflector pixel-addressed light deflection devices to change the angles of light emitted by the digital display device to properly focus on the retina of the user's eye (taking into account, factors such as distance to the user and the degree of optical correction needed to compensate for imperfections in the lens(es) of the user eye(s). Alternatively, the device and method can also compensate for color blindness by, for example, altering the focus of various colors on the retina of the user's eye. Although this will not enable a colorblind user to see true colors, still the altered focus would enable the user to distinguish colors that otherwise might not be distinguishable. The same sort of techniques might enable hyperspectral (e.g. more than the normal number of colors) vision for viewers with normal color vision.

The resolution (e.g. number of pixels per square inch or square centimeter) of the display screen and pixel deflector addressed light deflection devices may vary. Generally however, higher resolutions are preferred because it gives the system more flexibility and greater ability to cope with users with various types of impaired vision. Thus in the case where the display screen is a display pixel addressed display screen comprising a plurality of display pixels, the size of the display pixels can be either the same as, larger than, or smaller than the size of the deflector pixel-addressed light deflection devices.

Various types of deflector pixel-addressed light deflection devices may be used for this purpose.

In some embodiments, these deflector pixel-addressed light deflection devices can comprise a top layer of material directly situated on top of the display screen and configured to manipulate a path of light traversing said material. In other embodiments, these deflector pixel-addressed light deflection devices can be embedded inside said display screen.

In some embodiments, the material where the deflector pixel-addressed light deflection devices are embedded may be a piezoelectric or piezo magnetic material configured to adjust the operation of the various deflector pixel-addressed light deflection devices using any of applied electric, magnetic, heat, or ultrasonic energy.

In other embodiments, the deflector pixel-addressed light deflection devices can comprise various types of autostereoscopic liquid crystal displays, computer controllable parallax barriers, lenticular arrays, ultrasonic wave configured displays, and the like. Non-limiting examples of exemplary devices are taught in art such as Schulz, U.S. Pat. No. 8,339,444; Bimber US 2007/0081207; Hartkop US 2005/0275942; Holzbach U.S. Pat. No. 7,558,421; and Lipton U.S. Pat. No. 8,279,272; the complete contents of all of these applications being incorporated herein by reference.

In other embodiments (here called option “b”) which without being limiting may be particularly useful for compensating for astigmatism, the system may use the desired optical correction input and at least one computer processor to convolute the computer generated image prior to displaying the image on said display screen. Thus the system will display a desired optical correction convoluted image configured so that, after it passes through the distance to the user's eye and is further altered by the lens of the user's eye, the resulting image (first convoluted by the system and deconvoluted by the lens of the user's eye) will now properly focus on the retina(s) of the user's eye(s). In some embodiments, option “b” may be used without option “a”, and similarly option “a” may be used without option “b”.

However in some alternative embodiments, both option “a” and option “b” may be combined. For example, assume that the user has both sufficient myopia and astigmatism, such that to get the best possible image on the user's eye, use of both methods (e.g. using both deflector pixel-addressed light deflection devices to apply some degree of myopia correction, and also convoluting the computer generated image on the display screen so as to pre-compensate for the astigmatism) may be used to achieve optimum focus of the image on the retina(s) of the user's eye(s).

Although in a preferred embodiment, the system will employ a user observation sensor that will determine the distance between the display screen and the user's eye at least once, of course users may shift their position as they use the device. Thus in some embodiments, the user observation sensor(s) will determines this distance over a plurality of time intervals. Here the system's processor(s) can receive input regarding the desired optical correction at various times. The system's at least one processor can then use this input and said at least to, for example periodically update the angle adjustment commands (or image convolution parameters) over time in order to correct for changes in the distance between the user's eyes and the display screen.

The display devices and methods disclosed herein can be used in a wide variety of applications, including being used as a display component for a personal computer monitor, a laptop, a tablet or other computer device with a digital display. Other applications include use as an entertainment display such as an LCD, LED, plasma, HD, 3D or other television monitor; or for communication devices such as a mobile phone, a smart phone, or other mobile communication device. The display devices and methods disclosed herein can also be used for various types of wearable interfaces, including goggles, virtual reality headsets and helmets, wearable watches, and the like.

### Other Applications

In addition for vision correction purposes, the methods disclosed herein can be used for other applications, such as providing enhanced security. In this type of embodiment, assume that in addition to the user, there may be at least one other viewer (e.g. other humans, or even possibly undesired video cameras) that are also disposed at various distances or angles about the user's display screen. Here the viewer may not wish these other viewers to be able also view various images emitted by the display screen.

In this enhanced security scenario, the device's at least one computer processor can be configured into a “security setting” where it sends angle adjustment commands to the deflector pixel-addressed light deflection devices that are intended to both make the image properly focus for the user (e.g. on said retina of the user's eye), but not to properly focus for other viewers that presumably will be located in a different location (e.g. not located in the same position as the user's eyes).

The methods and devices disclosed herein can be used for other applications as well. Here, for example, the system can be “tuned” to improve the readability of screens even for users who have normal vision (i.e. 20/20). For example, in these embodiments, the system may be tuned to improve the readability of text displayed on the screen. Here for example, the display screen may be tuned so as to make it possible to read text smaller than a normal eye can read at a typical 30 cm distance from the screen. This would provide the user with better than normal vision and resolution (i.e. supervision). The same applies to seeing better details not affordable to uncorrected eyes for digital images and entertainment programs.

In some embodiments, the user's eyes may not have the same degree of focus or have other different optical characteristics. This can be due to the user's natural eyes, or perhaps may be caused by a user with eyes artificially focused at different distances by glasses, contact lenses, or eye surgery, so that for example one eye may be adjusted for distance viewing, and the other eye may be adjusted to focus at a closer distances.

For cases such as this, as well as other cases where user has two eyes that have different degrees of impairment, focus, and the like, the system may calculate and apply two different corrections. These different corrections may be applied, for example, on an alternating basis on the display screen, and/or applied to the previously discussed top layer material, optionally in an interlaced manner. Each eye will tend to adapt to the frame specifically corrected for it and thus both eyes will see clear images.

1. A method of modifying an image on a display screen of a digital display device so as to make said image properly focus on at least one retina of at least one eye of a user viewing said display screen, said method comprising:
receiving input regarding a desired optical correction needed to make said image properly focus on said at least one retina, and performing at least one of either
a) equipping said display screen with a plurality of deflector pixel-addressed light deflection devices, each said light deflection device configured to change an angle of light emitted by said digital display device according to commands from at least one computer processor; and
using said input and said at least one computer processor to send angle adjustment commands to at least some of said plurality of deflector pixel-addressed light deflection devices to configure at least some of said plurality of deflector pixel-addressed light deflection devices to change the angles of light emitted by said digital display device to properly focus on said at least one retina; or
b) using said input and at least one computer processor to convolute said image prior to displaying said image on said display screen, thereby displaying a convoluted image, said convolution based on said desired optical correction, said convolution configured so that said convoluted image will properly focus on said at least one retina.

2. The method of claim 1 where the display device is a component of any of:
a: a personal computer monitor, a laptop, a tablet or other computer device with a digital display; or
b: an entertainment display such as an LCD, LED, plasma, HD, 3D or other television monitor; or
c: a mobile phone, a smart phone, or other mobile communication device; or
d: wearable interfaces, goggles, virtual reality headsets and helmets, or wearable watches.

3. The method of claim 1, wherein said at least one eye has a natural impairment including any of:
a: sub-optimal focus due to any of myopia, hyperopia, presbyopia, astigmatism, anisometropia; or
b: color blindness or other color vision impairment of cone cells of said at least one retina; or
c: limited visual field angle.

4. The method of claim 1, wherein said input regarding a desired optical correction needed to make said image properly focus on said at least one retina comprises a distance between said at least one eye and said display screen, and wherein said distance comprises either a default value, or a user entered value.

5. The method of claim 1, wherein said digital display device further comprises at least one user observation sensor;
wherein said input regarding a desired optical correction comprises a distance between said at least one eye and said screen;
further using said at least one user observation sensor to determine said distance over at least one time interval.

6. The method of claim 5, wherein said at least one user observation sensor comprises at least one camera, or ultrasonic sensor, or optical scanner.

7. The method of claim 5, wherein said at least one user observation sensor determines said distance over a plurality of time intervals;
wherein said at least one processor receives input regarding said desired optical correction over said plurality of time intervals; and
further using said input and said at least one compute processor to periodically update said angle adjustment commands over said plurality of time intervals in order to correct for changes in said distance over said plurality of time intervals.

8. The method of claim 1, wherein said at least one computer processor further uses optical correction software or device installed optical correction hardware to send said angle adjustment commands.

9. The method of claim 1, wherein there are at least one other viewer also disposed at various distances or angles about said display screen so as to also view images emitted by said display screen;
wherein said at least one computer processor is configured to send angle adjustment commands intended to both make said image properly focus on said retina of the eye of said user, and also intended to make said image fail to properly focus for said at least one other viewers.

10. The method of claim 1, wherein said plurality of deflector pixel-addressed light deflection devices comprise a top layer of material directly situated on top of the display screen and configured to manipulate a path of light traversing said material.

11. The method of claim 10, wherein said material is a piezoelectric or piezo magnetic material configured to comprise said plurality of deflector pixel-addressed light deflection devices using any of applied electric, magnetic, heat, or ultrasonic energy.

12. The method of claim 1, wherein said plurality of deflector pixel-addressed light deflection devices are embedded inside said display screen.

13. The method of claim 1, wherein said display screen is also a display pixel addressed display screen comprising a plurality of display pixels;
wherein a size of said display pixels is either the same size as said deflector pixel-addressed light deflection devices, larger than said deflector pixel-addressed light deflection devices, or smaller than said deflector pixel-addressed light deflection devices.

14. A computerized digital display device with at least one display screen configured to display processor generated display pixel addressed images, and at least one processor, said device further configured adjust a focus of said display pixel addressed images to properly focus on at least one retina of at least one eye of a user viewing said display screen, said device comprising:
at least one processor configured to receive input regarding a desired optical correction needed to make said image properly focus on said at least one retina, and at least one of either:
a) at least one display screen configured with a plurality of deflector pixel-addressed light deflection devices, each light defection device configured to change an angle of light emitted by said digital display device according to commands from said least one processor; and
said processor further configured to use said input and said at least one computer processor to send angle adjustment commands to at least some of said plurality of deflector pixel-addressed light deflection devices to configure at least some of said plurality of deflector pixel-addressed light deflection devices to change the angles of light emitted by said digital display device to properly focus on said at least one retina; or
b) at least one processor configured to said input and to convolute said image prior to displaying said image on said display screen, thereby displaying a convoluted image, said convolution based on said desired optical correction, said convolution configured so that said convoluted image will properly focus on said at least one retina.

15. The device of claim 14, wherein said digital display device further comprises at least one user observation sensor configured to assume that said user has a head comprising various head features and dimensions, and to determine input regarding said desired optical correction by using said at least one user observation sensor to compute a distance between said user and said display screen using said various head features and dimensions over at least one time interval;
wherein said at least one user observation sensors comprises at least one camera, or ultrasonic sensor, or optical scanner.

16. The device of claim 15, wherein said at least one processor is configured to use said at least one user observation sensor to determine said distance over a plurality of time intervals;
said at least one processor is further configured to use said distance over said plurality of time intervals as input regarding said desired optical correction over said plurality of time intervals; and
said at least one processor is further configured to periodically update said angle adjustment commands over said plurality of time intervals in order to correct for changes in said distance over said plurality of time intervals.

17. The device of claim 15, wherein said at least one processor is configured to use said at least one user observation sensor to determine if there are other viewers also disposed at various distances or angles about said display screen; and
wherein said at least one computer processor is further configured to send angle adjustment commands intended to both make said image properly focus on said at least one retina of said at least one eye of said user, and also intended to make said image fail to properly focus for said at least one other viewers.

18. The device of claim 14, wherein said plurality of deflector pixel-addressed light deflection devices comprise a top layer of material directly situated on top of the display screen and configured to manipulate a path of light traversing said material; or
wherein said plurality of deflector pixel-addressed light deflection devices are embedded inside said display screen.

19. The device of claim 18, wherein said material is a piezoelectric or piezo magnetic material configured to comprise said plurality of deflector pixel-addressed light deflection devices using any of applied electric, magnetic, heat, or ultrasonic energy.

20. The device of claim 14, wherein said display screen is also a display pixel addressed display screen comprising a plurality of display pixels;
wherein a size of said display pixels is either the same size as said deflector pixel-addressed light deflection devices, larger than said deflector pixel-addressed light deflection devices, or smaller than said deflector pixel-addressed light deflection devices.
